(19) United States
(12) Patent Application Publication
(10) Pub. No.: US 2014/0379747 A1
(43) Pub. Date: Dec. 25, 2014

(54) IDENTIFYING RELEVANT APPS IN RESPONSE TO QUERIES

(71) Applicant: Microsoft Corporation, Redmond, WA (US)

(72) Inventors: RANGAN MAJUMDER, Redmond, WA (US); ELBIO RENATO ABIB, Bellevue, WA (US); LIWEI CHEN, Seattle, WA (US); YU JIAO, Bellevue, WA (US); WILLIAM D. RAMSEY, Redmond, WA (US); NICHOLAS ERIC CRASWELL, Seattle, WA (US); BETTY YEE MAN CHENG, Bellevue, WA (US)

(21) Appl. No.: 13/921,892

(22) Filed: Jun. 19, 2013

(51) Int. Cl. G06F 17/30

(52) U.S. Cl. CPC G06F 17/30864
USPC 707/769

(57) ABSTRACT

Systems, methods, and computer-readable storage media are provided for permitting users to search the content of a plurality of apps from a single search query input location. A user inputs a search query and a plurality of apps and/or the content thereof is searched to determine relevancy to the input query. If an app having relevant app content is identified, it may be determined if the app is associated with the querying user. If it is determined that the app is associated with the querying user, the information determined relevant to the input query may be presented to the user. If, it is determined that the app is not associated with the user, the user may be presented with the identity of the app and/or be directed to a location (e.g., an app store) where the user can become associated with the identified app and obtain the desired information.

### BACKGROUND

With the recent trend in the “appification” of the web, users increasingly are spending time utilizing apps (that is “applications”—generally small, specialized programs users download onto their mobile devices) like YELP, EVERNOTE, and the like. In fact, on many devices, users spend more time on apps than they do on the web. Currently, however, in order to search the content of any particular app, users must open the particular app and initiate a search within the app itself. For example, a user desiring to obtain information about and/or watch the movie “Mission Impossible” must first determine which app to search (e.g., HULU, NETFLIX, HBO, IMDB, etc.) and then launch the chosen app to conduct a search within it. There are a number of limitations to this approach. First, users may not know which apps have the desired content and, accordingly, may not be able to adequately choose which app or apps to search. Second, app providers are not as adept at search methodologies as others having a specific specialty in search functionality, for instance, Microsoft Corporation of Redmond, Wash. Accordingly, users may not be able to access the desired information from an input search query as efficiently as they would like. Further, users may desire multiple information items and/or actions with respect to a particular query, each item and/or action being available through a different app. As such, separate queries conducted within multiple apps may be necessary to achieve a user's end goal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided that allow users to search a plurality of apps (that is “applications”—generally small, specialized programs users download onto their mobile devices) and/or the content thereof from a single search query input location. A user inputs a search query into the single search query input location and a plurality of apps and/or the content thereof is searched to determine relevancy to the input query. In embodiments, if an app having relevant app content is identified, it may be determined if the app is associated with the querying user, e.g., it may be determined if the user has downloaded the app to his or her computing device. If it is determined that the app is associated with the querying user, embodiments of the invention provide for the presentation of the information determined relevant to the input query. If, however, it is determined that the app is not associated with the user, in accordance with embodiments hereof, the user may be presented with the identity of the app and/or be directed to a location (e.g., an app store) where the user can become associated with the identified app and obtain the desired information.

Embodiments of the present invention provide avenues for users to search multiple apps and the content thereof simultaneously and from a single search query input location, thus diminishing the need to open and individually search a number of apps to obtain desired content. Further, embodiments of the present invention provide for leveraging sophisticated search methodologies in searching the content of apps, thus providing a more efficient app content search capability.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for identifying apps having relevant content in response to search queries, in accordance with an embodiment of the present invention;

FIG. 4 is a flow diagram showing another exemplary method for identifying apps having relevant content in response to search queries, in accordance with an embodiment of the present invention; and

FIG. 5 is a flow diagram showing yet another exemplary method for identifying apps having relevant content in response to search queries, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for allowing users to search the content of a plurality of apps from a single search query input location. In accordance with embodiments hereof, a user is permitted to input a search query into the single search query input location and a plurality of apps and/or the content thereof is searched to determine relevancy to the input query. In embodiments, if an app having relevant app content is identified, it may be determined if the app is associated with the querying user, e.g., it may be determined if the user has downloaded the app to his or her computing device. If it is determined that the app is associated with the querying user, embodiments of the invention provide for the presentation of the information determined relevant to the input query. If, however, it is determined that the app is not associated with the user, in accordance with embodiments hereof, the user may be presented with the identity of the app and/or be directed to a location (e.g., an app store) where the user can become associated with the identified app and obtain the desired information.

Utilizing embodiments of the present invention, organizations that are adept at search methodologies (e.g., Microsoft Corporation of Redmond, Wash.) may be leveraged to conduct app searches, even though such searches may be initiated outside of the web environment. Generally, app content providers have limited exposure to or expertise in such search methodologies and, accordingly, searches conducted within an app by the app itself, result in sub-optimal results. Embodiments of the present invention allow for the use of more sophisticated search methodologies within apps without app publishers having to invest time and money into ensuring their users can find desired content efficiently and easily.

Accordingly, one embodiment of the present invention is directed to one or more computer-readable storage media storing computer-useable instructions that, when used by one or more computing devices, cause the one or more computing devices to perform a method for identifying apps having relevant content in response to search queries. The method includes receiving a search query from a user; searching app content associated with a plurality of apps; and identifying, based upon the searching of the app content associated with the plurality of apps, at least one app having app content relevant to the received search query.

In another embodiment, the present invention is directed to a method being performed by one or more computing devices including at least one processor, the method for identifying apps having relevant content in response to search queries. The method includes receiving a search query from a user and identifying at least one app having app content relevant to the received search query based on at least one of (1) searching app content associated with the plurality of apps, (2) inferring app content based upon aggregate user behavior, and (3) behavior of the querying user.

In yet another embodiment, the present invention is directed to a system including a search engine having one or more processors and one or more computer-readable storage media and a data store coupled with the search engine. The search engine is configured to receive app content associated with a plurality of apps; receive a search query from a user; identify at least one app having app content relevant to the received search query; determine that the at least one app is associated with the user; and present at least a portion of the app content relevant to the received search query. In embodiments, the at least one app is identified based on at least one of (1) searching app content associated with a plurality of apps, (2) inferring app content based upon aggregate user behavior, and (3) behavior of the querying user. In embodiments, the presented portion of the app content that is relevant to the search query is other than a home page or other default landing page associated with the at least one app.

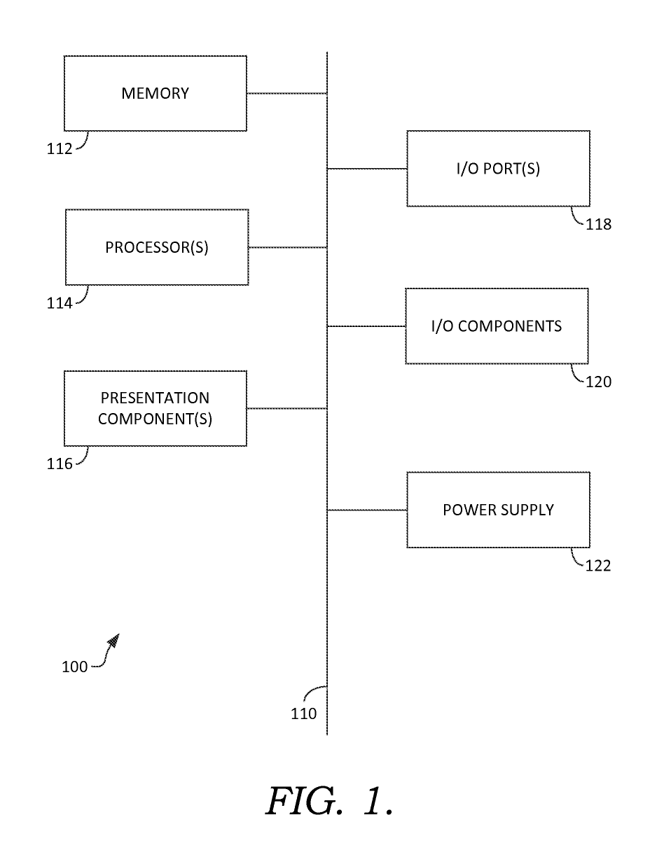

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including, but not limited to, hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as search requests, words or symbols appearing in apps available for retrieval in response to input search requests, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

Furthermore, although the term “search engine” is used herein, it will be recognized that this term may also encompass servers, web browsers, sets of one or more processes distributed on one or more computers, one or more stand-alone storage devices, sets of one or more other computing or storage devices, any combination of one or more of the above, and the like.

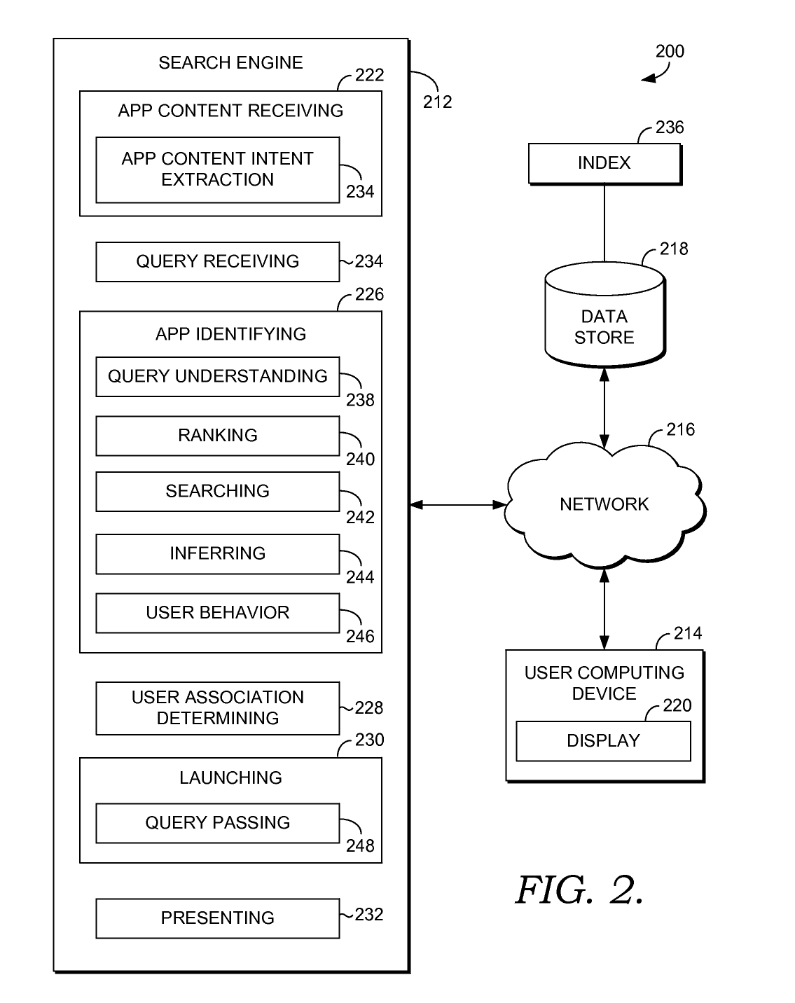

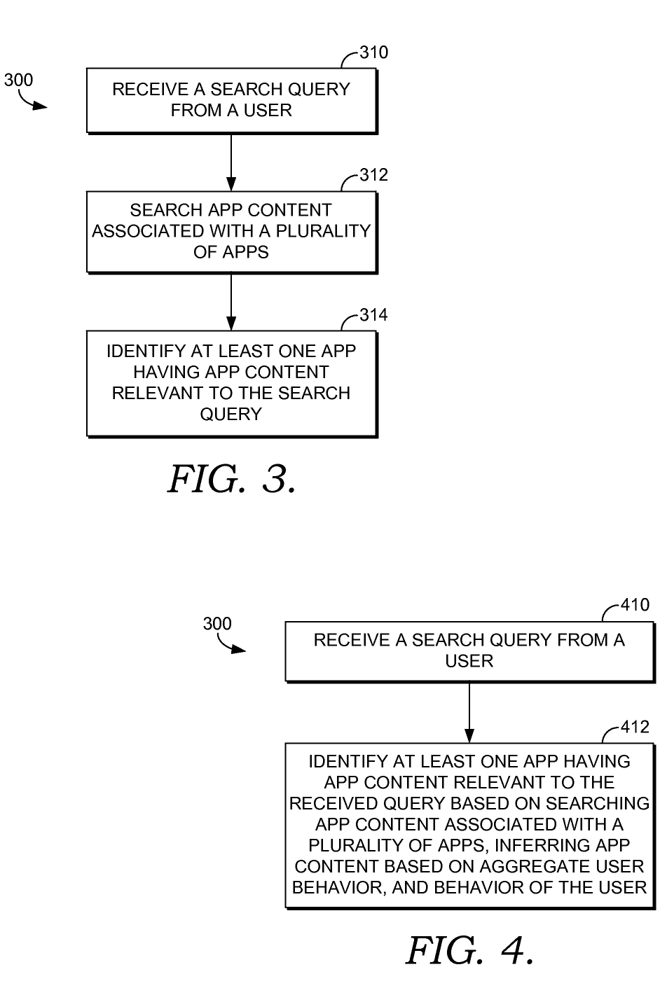

As previously set forth, embodiments of the present invention provide systems, methods, and computer-readable storage media that allow users to search the content of a plurality of apps from a single search query input location. With reference to FIG. 2, a block diagram is provided illustrating an exemplary computing system 200 in which embodiments of the present invention may be employed. Generally, the computing system 200 illustrates an environment in which the identity of apps and/or app content relevant to an input search query may be provided in response to the query, in accordance with the methods, for instance, illustrated in FIGS. 3, 4 and 5 (more fully described below). Among other components not shown, the computing system 200 generally includes a search engine 212 and a user computing device 214 in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of user computing devices and/or search engines may be employed in the computing system 200 within the scope of embodiments of the present invention. Each may comprise a single device/interface or multiple devices/interfaces cooperating in a distributed environment. For instance, the search engine 212 may comprise multiple devices and/or modules arranged in a distributed environment that collectively provide the functionality of the search engine 212 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the user computing device 214, the search engine 212, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engines and/or user computing devices. By way of example only, the search engine 212 might be provided as a single computing device, a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown and/or described, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 214 may include any type of computing device, such as the computing device 100 described with reference to FIG. 1, for example. Generally, the user computing device 214 includes a display 220. The display 220, among other things, is configured to receive user input search queries (generally input via a user interface presented on the display 220 and permitting alpha-numeric and/or textual input into a designated search input region) and to receive content for presentation, for instance, from the search engine 212. The display 220 is further configured to present received content, e.g., search results. It should be noted that embodiments of the present invention are equally applicable to desktop devices; laptop devices, tablets and other mobile computing devices; and devices accepting touch, gesture and/or voice input. Any and all such variations, and any combination thereof, are contemplated to be within the scope of embodiments of the present invention.

The search engine 212 of the computing system 200 of FIG. 2 is configured to, among other things, receive search queries and provide search results, at least in the form of app content, in response thereto. As illustrated, the search engine 212 has access to a data store 218. The data store 218 is configured to store information related to one or more search queries, identities associated with a plurality of apps, app content, specific user behavior, aggregate user behavior patterns and the like. In embodiments, the data store 218 is configured to be searchable for one or more of the items stored in association therewith. It will be understood and appreciated by those of ordinary skill in the art that the information stored in association with the data store may be configurable and may include any information relevant to search queries, apps, user behavior (specific and aggregate) and the like. The content and volume of such information are not intended to limit the scope of embodiments of the present invention in any way. Further, the data store 218 may be a single, independent component or a plurality of storage devices, for instance a database cluster, portions of which may reside in association with the search engine 212, the user computing device 214, another external computing device (not shown), and/or any combination thereof.

As illustrated, the search engine 212 includes an app content receiving component 222, a search query receiving component 224, an app identifying component 226, a user association determining component 228, an app and/or app store launching component 230, and a presenting component 232. The app content receiving component 222 is configured to receive app content associated with a plurality of apps. App content may be received via a content feed provided by the provider, publisher, or the like of a particular app and/or, by way of example only, utilizing one or more protocols, implicit app content crawling, or mapping to associated web content. For instance, app providers may provide a content feed containing their app content and/or they may map web content associated with their app content utilizing an identifier. In some embodiments, for instance, when app content is received utilizing a specific protocol, the data store 218 may include an index 236 to aid in storing and organizing the received app content. Any and all such variations, and any combination thereof, are contemplated to be within the scope of embodiments of the present invention. It will be understood and appreciated by those of ordinary skill in the art that the delineated methods of receiving app content are provided only by way of illustration and are not intended to limit the scope of embodiments of the present invention in any way.

In embodiments, the app content receiving component 222 may include an app content intent extraction sub-component 234 configured to extract the intent of the app from which the app content is received. In this way, terms and/or concepts that may be ambiguous when taken out of context may be better understood and the relevance of search results provided to a user in response to an input search query (more fully described below) may be improved. Methodologies for extracting intent from content are known to those of ordinary skill in the art and, accordingly, are not further described herein.

The search query receiving component 224 is configured to receive search queries input by a user. Generally, user search queries may be input via a user interface presented on the display 220 of the user computing device 214 that permits alpha-numeric and/or textual input into a designated search input region. In embodiments, the search query receiving component 224 is additionally configured to accept touch, gesture and/or voice input search queries. Any and all such variations, and any combination thereof, are contemplated to be within the scope of embodiments of the present invention.

The app identifying component 226 is configured to identify at least one app having app content that is relevant to a search query received by the search query receiving component 224. Apps may be identified in a number of ways including, without limitation, by searching the app content associated with one or more apps, by inferring app content based upon aggregate user behavior, and by examining behavior (past and/or current) of the querying user. In this regard, the app identifying component 226 may include a searching sub-component 242, an inferring sub-component 244, and/or a user behavior sub-component 246.

The searching sub-component 242 is configured to search app content (stored, for instance, in association with the data store 218) for content relevant to an input search query. In embodiments, the searching sub-component 242 further may be configured to search any app content intent information extracted from an app by the app content intent extraction sub-component 234 of the app content receiving component 222.

The inferring sub-component 244 is configured to infer app content based upon aggregate user behavior. For instance, suppose the content of a particular app, App A (e.g., ROTTEN TOMATOES), is unavailable in the data store 218. Suppose further, however, that users querying for a particular type of information (e.g., movie ratings) often end up consulting App A before completing his or her search session. The inferring sub-component 244 may infer that App A has information relevant to a query for the particular type of information and identify App A in response to the query, despite not having access to the actual content thereof. Even if the app content associated with App A is available in the data store 218, the inferring sub-component 244 further may be configured to infer preference or importance to users of App A for utilization in ranking apps relative to one another in response to the search query, as more fully described below. Any and all such variations, and any combination thereof, are contemplated to be within the scope of embodiments of the present invention.

The user behavior sub-component 246 is configured to examine behavior of a querying user, past and/or present, and utilize such behavior to identify apps in response to an input search query. For instance, if the querying user recently has conducted a search session for movie reviews utilizing the web, or regularly consults a particular app or web site (e.g., ROTTEN TOMATOES) when searching for movie reviews, the user behavior sub-component 246 may utilize this information to identify ROTTEN TOMATOES as a relevant app upon receiving a query from the user regarding movie reviews. Further, the user behavior sub-component 246 may be configured to utilize the behavior of the querying user to infer preference or importance to the querying user of a particular app for utilization in ranking apps relative to one another in response to the search query, as more fully described below. Still further, the user behavior sub-component 246 may be configured to utilize information about the querying user other than behavior (e.g., profile information, location information, and the like) in identifying relevant apps in response to an input search query. Any and all such variations, and any combination thereof, are contemplated to be within the scope of embodiments of the present invention.

As illustrated, the app identifying component 226 of the search engine 212 further includes a query understanding sub-component 238 and a ranking sub-component 240. The query understanding sub-component 238 is configured to extract the intent of an input search query. In this way, terms and/or concepts that may be ambiguous when taken out of context may be better understood and the relevance of search results provided to the user in response to the input search query may be improved. Methodologies for extracting intent from content are known to those of ordinary skill in the art and, accordingly, are not further described herein.

The ranking sub-component 240 of the app identifying component 226 is configured to utilize signals received from the query understanding sub-component 238, the searching sub-component 242, the inferring sub-component 244 and the user behavior sub-component 246 to rank apps relative to one another in terms of relevance to the input search query and to the user. Generally, a plurality of apps is identified as relevant in response to an input search query. The ranking sub-component 240 is configured to rank the identified apps such that those determined to be more relevant when all available information is taken into account may be presented to the user (as more fully described below) either exclusively or more prominently than those determined to be less relevant. Ranking methodologies are well known to those of ordinary skill in the art and, accordingly, are not further described herein.

At times, apps identified by the app identifying component 226 of the search engine 212 as relevant to an input search query will be apps with which the user is not associated, e.g., apps that the user has not downloaded to his or her device. Yet, app content providers generally do not wish for users that are not associated with their apps to have access to the app content contained therein. Accordingly, the user association determining component 228 is configured to determine whether or not the querying user is associated with one or more of the apps identified as relevant to the input search query. If it is determined that the querying user is associated with an app determined to be relevant, the content of the app may be presented to the user utilizing the presenting component 232 of the search engine 212, as more fully described below.

However, if it is determined that the querying user is not associated with an app determined to be relevant to an input search query, a number of options are available. For instance, the app with which the user is not associated may simply be eliminated from the identified relevant apps and, thus, not exposed to the user in any way. This option, however, is not particularly useful to the user as he or she may not realize that there is an app available that contains the most relevant desired content. Thus, another alternative upon determining an app with which the querying user is not associated is relevant and/or contains relevant content is to identify the app to the user as an app that may contain relevant content to the input search query and/or other queries of the same or a similar type without revealing any app content determined to be relevant. The user then may determine whether or not he or she desires to become associated with the identified app and receive access to the content thereof. Identification of the app to the user may be by way of a message presented to the user as a solely informational message leaving it up to the user to launch a program from which he or she may obtain the app if desired. Or, identification of the app may result in automatically launching an app store or other program from which the identified app may be obtained, for instance, utilizing the launching component 230 of the search engine 212. Thus, the launching component 230 is configured to automatically launch a program from which an app may be obtained (e.g., an app store) upon identification of an app or app content with which a querying user is not associated and that may be relevant to an input search query.

As previously mentioned, at times the search engine 212 may not have access to app content associated with certain apps but may still be able to identify such apps as relevant to an input search query based, for instance, on aggregate and/or specific user behavior, and the like. In such instances, once an app has been identified as relevant to an input search query, the search engine is unable to effectively search the app content creating a need for the app itself to conduct a search of its content to identify the specific content that is relevant to the input search query. As such, the launching component 230 additionally is configured to launch one or more apps identified as relevant and pass the query to the app itself (e.g., utilizing the query passing sub-component 248) for searching the content contained in association therewith.

The presenting component 232 is configured to transmit for presentation, for instance, in association with the user computing device 214, an identity associated with apps identified as relevant to an input search query, at least a portion of content of apps identified as relevant to an input search query, messages regarding apps identified as relevant to an input search query, and the like. In embodiments, the portion of the content of apps identified as relevant to an input search query that is presented is other than a home page associated with the at least one app. That is, the portion of the app content that is presented would be content that is specific to the input search query rather than to the app in general. For instance, if ROTTEN TOMATOES is identified as a relevant app to an input search query regarding review of the movie “Mission Impossible,” the portion of the app content that is presented would be a page containing a movie review of “Mission Impossible” rather than the ROTTEN TOMATOES app home page. This may be accomplished, by way of example only, with a protocol that utilizes identifiers associating web content to app content, as discussed above. Presentation in accordance with embodiments hereof may be visual (for instance, in association with the display 220 of the user computing device 214), audible, or any combination thereof.

Turning now to FIG. 3, a flow diagram is illustrated showing an exemplary method 300 for identifying apps having relevant content in response to search queries. As indicated at block 310, a search query is received from a user, for instance, by search query receiving component 224 of the search engine 212 of FIG. 2. App content associated with a plurality of apps is searched, as indicated at block 312 (e.g., utilizing the searching sub-component 242 of the app identifying component 226 of FIG. 2). Based upon the search of the app content associated with the plurality of apps, at least one app is identifying that has app content relevant to the received search query, as indicated at block 314. This may be done, for instance, utilizing the app identifying component 226 of the search engine 212 of FIG. 2.

With reference now to FIG. 4, a flow diagram is illustrated showing an exemplary method 400 for identifying apps having relevant content in response to search queries. As indicated at block 410, a search query is received from a user, for instance, by search query receiving component 224 of the search engine 212 of FIG. 2. As indicated at block 412, at least one app is identified (e.g., utilizing the app identifying component 226 of the search engine 212 of FIG. 2), the at least one app having app content relevant to the received search query. The at least one app is identified based on at least one of searching app content associated with the plurality of apps, inferring app content based upon aggregate user behavior, and behavior of the querying user.

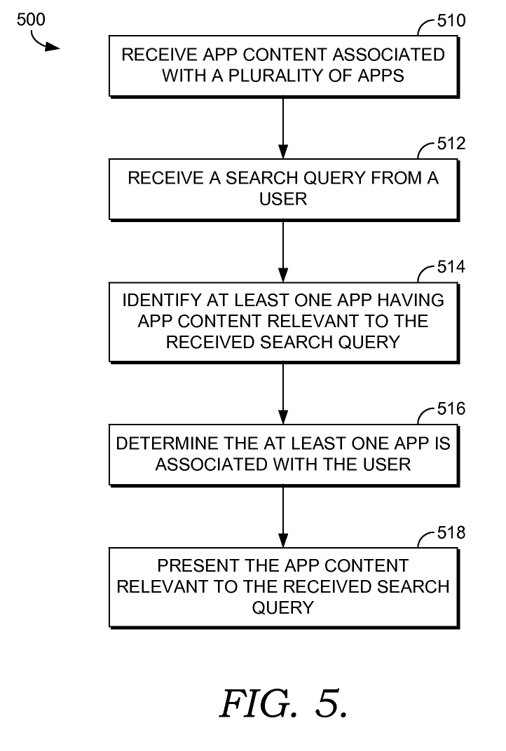

Turning to FIG. 5, a flow diagram is illustrated showing yet another exemplary method 500 for identifying apps having relevant content in response to search queries. As indicated at block 510, app content associated with a plurality of apps is received, for instance, utilizing app content receiving component 222 of the search engine 212 of FIG. 2. In embodiments the app content is received utilizing one or more of a protocol, implicit app content crawling, mapping to associated web content, and content feeds from providers associated with the plurality of apps.

A search query is received from a user, for instance, by search query receiving component 224 of the search engine 212 of FIG. 2. This is indicated at block 512. As indicated at block 514, at least one app is identified (e.g., utilizing the app identifying component 226 of the search engine 212 of FIG. 2) having app content relevant to the received search query. The at least one app is identified based on at least one of searching app content associated with the plurality of apps, inferring app content based upon aggregate user behavior, and behavior of the querying user.

As indicated at block 516, it is determined that the at least one app is associated with the user, for instance, utilizing the user association determining component 228 of the search engine 212 of FIG. 2. At least a portion of the app content relevant to the received search query is presented (e.g., utilizing the presenting component 232 of the search engine 212 of FIG. 2), for instance, in association with the display 220 of the user computing device 214 of FIG. 2. In embodiments, the presented portion of the app content is other than a home page associated with the at least one app.

As can be understood, embodiments of the present invention provide systems, methods, and computer-readable storage media for, among other things, permitting users to search the content of a plurality of apps from a single search query input location. Embodiments provide avenues for users to search multiple apps and the content thereof simultaneously and from a single search query input location, thus diminishing the need to open and individually search a number of apps to obtain desired content. Further, embodiments of the present invention provide for leveraging sophisticated search methodologies in searching the content of apps, thus providing a more efficient app content search capability.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIG. 3, 400 of FIGS. 4, and 500 of FIG. 5 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for identifying apps having relevant content in response to search queries, the method comprising:
receiving a search query from a user;
searching app content associated with a plurality of apps; and
identifying, based upon the searching of the app content associated with the plurality of apps, at least one app having app content relevant to the received search query.

2. The one or more computer-readable storage media of claim 1, wherein the method further comprises presenting at least a portion of the relevant app content associated with the identified at least one app.

3. The one or more computer-readable storage media of claim 2, wherein the portion of the relevant app content associated with the identified at least one app is other than a home page associated with the at least one app.

4. The one or more computer-readable storage media of claim 2, wherein the method further comprises determining that the at least one app is associated with the user prior to presenting the portion of the relevant app content associated with the identified at least one app.

5. The one or more computer-readable storage media of claim 1, wherein the method further comprises:
launching the at least one app; and
passing the received search query to the at least one app for conducting a search.

6. The one or more computer-readable storage media of claim 5, wherein the method further comprises determining that the at least one app is associated with the user prior to launching the at least one app.

7. The one or more computer-readable storage media of claim 1, wherein the method further comprises:
determining that the at least one app is not associated with the user; and
presenting an identity associated with the at least one app.

8. The one or more computer-readable storage media of claim 7, wherein the method further comprises automatically launching an app store having the at least one app associated therewith.

9. The one or more computer-readable storage media of claim 1, wherein the method further comprises receiving the app content associated with the plurality of apps utilizing one or more of a protocol, implicit app content crawling, mapping to associated web content, and content feeds from providers associated with the plurality of apps.

10. A method being performed by one or more computing devices including at least one processor, the method for identifying apps having relevant content in response to search queries, the method comprising:
receiving a search query from a user; and
identifying at least one app having app content relevant to the received search query based on at least one of searching app content associated with a plurality of apps, inferring app content based upon aggregate user behavior, and behavior of the querying user.

11. The method of claim 10, further comprising presenting at least a portion of the relevant app content associated with the identified at least one app.

12. The method of claim 11, wherein the portion of the relevant app content associated with the identified at least one app is other than a home page associated with the at least one app.

13. The method of claim 11, further comprising determining that the identified at least one app is associated with the user prior to presenting the portion of the relevant app content associated with the identified at least one app.

14. The method of claim 10, further comprising:
launching the at least one app; and
passing the received search query to the at least one app for conducting a search.

15. The method of claim 14, further comprising determining that the at least one app is associated with the user prior to launching the at least one app.

16. The method of claim 10, further comprising:
determining that the at least one app is not associated with the user; and
presenting an identity associated with the at least one app.

17. The method of claim 16, further comprising automatically launching an app store having the at least one app associated therewith.

18. The method of claim 10, wherein the method further comprises receiving the app content associated with the plurality of apps utilizing one or more of a protocol, implicit app content crawling, mapping to associated web content, and content feeds from providers associated with the plurality of apps.

19. A system comprising:
a search engine having one or more processors and one or more computer-readable storage media; and
a data store coupled with the search engine,
wherein the search engine:
receives app content associated with a plurality of apps;
receives a search query from a user;
identifies at least one app having app content relevant to the received search query based on at least one of searching app content associated with the plurality of apps, inferring app content based upon aggregate user behavior, and behavior of the querying user;
determines that the at least one app is associated with the user; and
presents at least a portion of the app content relevant to the received search query, the portion being other than a home page associated with the at least one app.

20. The system of claim 19, wherein the search engine further receives the app content associated with the plurality of apps utilizing one or more of a protocol, implicit app content crawling, mapping to associated web content, and content feeds from providers associated with the plurality of apps
